(19) United States
(12) Patent Application Publication
(10) Pub. No.: US 2019/0317753 A1
(43) Pub. Date: Oct. 17, 2019

(54) FIRMWARE UPDATE SYSTEM

(71) Applicant: Onkyo Corporation, Osaka (JP)

(72) Inventor: Takashi NAKABE, Osaka (JP)

(21) Appl. No.: 16/383,617

(22) Filed: Apr. 14, 2019

(30) Foreign Application Priority Data
Apr. 16, 2018 (JP) 2018-078459

(51) Int. Cl. G06F 8/65

(52) U.S. Cl. CPC G06F 8/65

(57) ABSTRACT

A server comprising: a controller; wherein the controller sends update notices of firmware to electronic devices of predetermined units per predetermined time.

### CROSS-REFERENCE TO RELATED APPLICATIONS

This application claims priority to Japanese Application No. 2018-078459, filed Apr. 16, 2018, the entire contents of which are incorporated herein by reference.

### FIELD

The present disclosure relates to a firmware update system which updates a firmware and a server composing the firmware update system.

### BACKGROUND

In an electronic device such as an AV receiver, there is a device which can update a firmware via a network (for example, see JP 2015-138297 A.) An update package for updating the firmware is provided in a server. The update packages of one kind for each model are provided in the server. For example, there are cases where CGIs (Common Gateway Interface) for download are prepared in separate folders for a package for real update and a package for test upload and cases of update are divided.

However, a package which is to be updated is one folder for performance. For this reason, all electronic devices perform the same access. In this case, there is possibility that a problem that server accesses are concentrated and it takes a long time for download occurs because timing of accesses from the electronic devices to the server is the same when the update is released. Further, there may be a problem that if there may be serious bugs in a released package, the package with the bugs is spread over as the package is updated all at once.

As a solution of the above-described problem, there is a method which limits downloads from the update server by designating MAC (Media Access Control) addresses so as to limit update and limit publication range. However, it is necessary that MAC addresses are managed in a factory and MAC addresses and serial numbers are associated. When AV receivers are made in multiple bases, there is a cost for management and realization is difficult.

### SUMMARY OF THE INVENTION

According to one aspect of the disclosure, there is provided a server comprising: a controller; wherein the controller sends update notices of firmware to electronic devices of predetermined units per predetermined time.

### BRIEF DESCRIPTION OF THE DRAWINGS

FIG. 1 is a block diagram illustrating a configuration of a firmware update system according to an embodiment of the present invention.

FIG. 2 is a block diagram illustrating a configuration of an AV receiver.

FIG. 3 is a flow chart illustrating processing operation of a server.

FIG. 4 is a diagram illustrating an image which sets number limit per an hour and clears limit per 24 hours.

FIG. 5 is a diagram illustrating a table in which MAC addresses are recorded.

### DETAILED DESCRIPTION OF THE PREFERRED EMBODIMENTS

An objective of the present invention is to control update of a firmware by an electronic device.

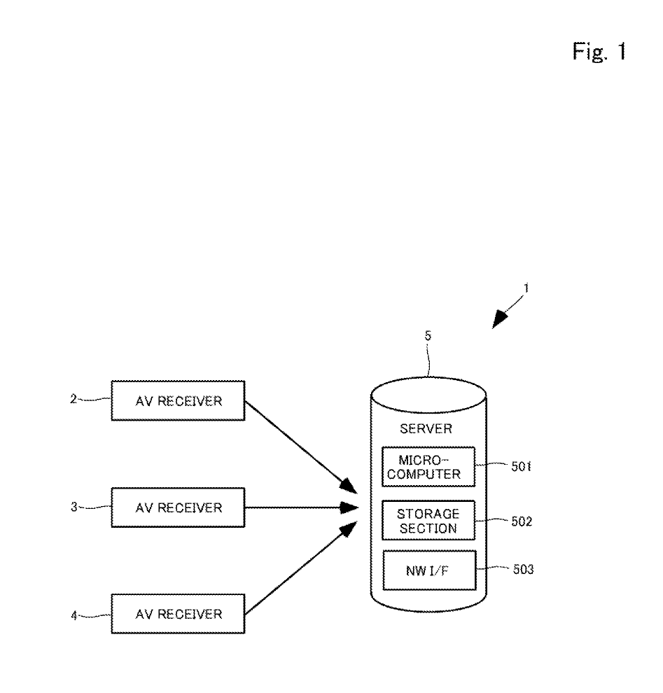

Hereinafter, an embodiment of the present disclosure will be described. FIG. 1 is a block diagram illustrating a firmware update system 1 according to the present embodiment. As illustrated in FIG. 1, the firmware update system 1 includes AV receivers 2 to 4 and a server 5.

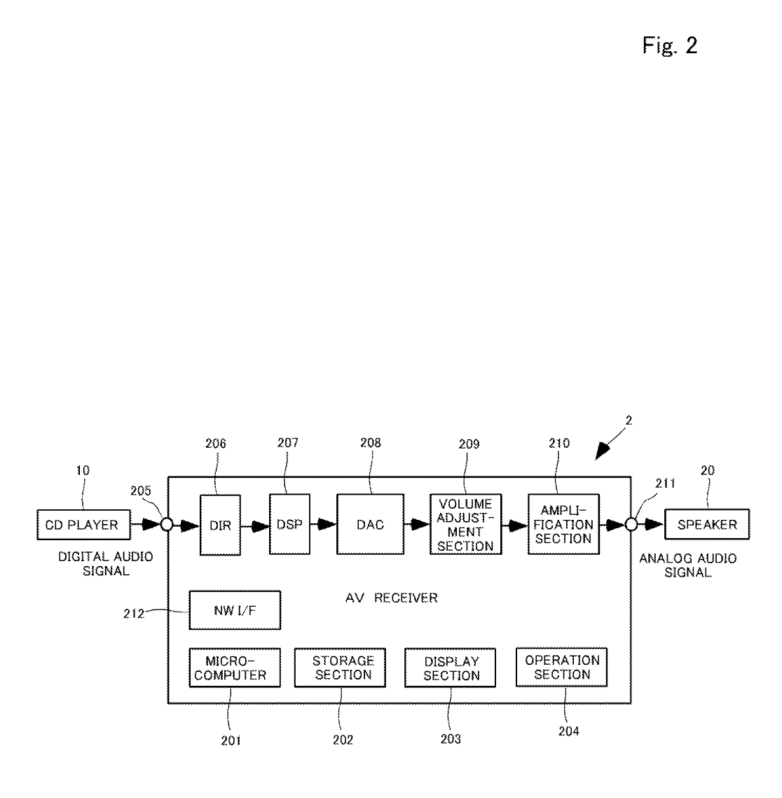

FIG. 2 is a block diagram illustrating the AV receiver 2. The AV receivers 2 to 4 are the same configuration. For this reason, the AV receiver 2 is described. For example, the AV receiver 2 (electronic device) performs audio processing such as amplification to an audio signal which is output from a CD player 10 and outputs the audio signal to a speaker 20.

As illustrated in FIG. 2, the AV receiver 2 includes a microcomputer 201, a storage section 202, a display section 203, an operation section 204, a digital signal input terminal 205, a DIR (Digital Interface Receiver) 206, a DSP (Digital Signal Processor) 207, a D/A converter (hereinafter referred as to “DAC”) 208, a volume adjustment section 209, an amplifier 210, a speaker terminal 211, and a network interface (hereinafter referred as to “NW I/F”) 212.

The microcomputer 201 is composed of hardware such as a CPU (Central Processing Unit), a ROM (Read Only Memory) and a RAM (Random Access Memory). The microcomputer 201 controls respective sections composing the AV receiver 2 according to a program which is stored in the ROM. The RAM functions as a main memory of the CPU. The ROM stores a program. The storage section 202 stores firmware.

The display section 203 displays a setting screen and so on, and is an LCD (Liquid Crystal Display) or a vacuum fluorescent display. The operation section 204 is for receiving user operation and is operation buttons which are provided at an enclosure of the AV receiver 2 and or a remote controller. For example, a user can direct a volume value of an audio signal to the AV receiver 2 by operating the operation section 204.

The CD player 10 is connected to the digital signal input terminal 205. An SPDIF signal is input to the digital signal input terminal 205 from the CD player 10. The DIR 206 converts the SPDIF signal which is input from the CD player 10 into an I2S signal. The converted I2S signal is output to the DSP 207. The DSP 207 performs digital signal processing such as equalizer processing to the I2S signal. The I2S signal subjected to the digital signal processing is output to the DAC 208. The DAC 208 D/A-converts the I2S signal into an analog audio signal. The

D/A-converted analog audio signal is output to the volume adjustment section 209.

The volume adjustment section 209 adjusts a volume value of the analog audio signal. The analog audio signal the volume value of which is adjusted is output to the amplifier 210. The amplifier 210 amplifies the analog audio signal the volume value of which is adjusted. The amplified analog audio signal is output to the speaker terminal 211. The speaker 20 is connected to the speaker terminal 211. The speaker 20 outputs an audio based on the analog audio signal.

The NW I/F 212 is for communicating with an external device via a network. The CPU 201 communicates with the external device (the server 5) via the network by the NW I/F 212.

The server 5 includes a microcomputer 501, a storage section 502, and a network interface (hereinafter referred as to “NW I/F”) 503. The microcomputer 501 (second controller) is composed of hardware such as a CPU, a RAM, and a ROM. The CPU controls respective sections composing the server 5 according to a program which is stored in the ROM. The RAM functions as a main memory of the CPU. The ROM stores a program. The storage section 502 (second storage section) stores update packages and MAC addresses (network addresses). The NW I/F 503 is for communicating with an external device. The CPU 501 communicates with external devices (the AV receivers 2 to 4) via the network by the NW I/F 503.

The microcomputer 501 sends notices which indicate performing update display of firmware (header information with update display, update notice of firmware) to AV receivers of M units (predetermined units) per one day (predetermined time). In other words, the microcomputer 501 limits number of notices which indicate performing update display of firmware which is sent to the AV receivers to M units per one day (predetermined time), for example. Further, when the microcomputer 501 sends notices which indicate performing update display of firmware to AV receivers of M units (predetermined units) per one day (predetermined time), the microcomputer 501 sends notices which indicate not to perform update display of firmware (header information without update display, notice indicating no update of a firmware) to the other AV receivers. In this manner, the header information without update display and the header information with update display are used. Publication package which is prepared in the server 5 is one.

When the microcomputer 501 counts accesses times and access times are within access limit count (M times), the microcomputer 501 sends the header information with update display to the AV receivers. When the microcomputer 501 counts accesses times and access times are more than access limit count (M times) per one day, the microcomputer 501 sends the header information without update display to the AV receivers. When there is an access from the AV receiver, the microcomputer 501 counts access times from the AV receivers by subtracting one from access limit count (M times) (access limit count−1). Therefore, when access limit count is not 0, the microcomputer 501 sends the header information with update display to the AV receivers. When access limit count is 0, the microcomputer 501 sends the header information without update display to the AV receivers.

For example, as a place of destination, when there are America, Europe, and Japan, distinction is made between destinations, and when there is an access in each destination from 0 o'clock to 24 o'clock, update notices are preformed to AV receivers of first arrival M units. Therefore, when there is update check (file demand) against the server from AV receivers, the microcomputer 501 refers to access limit count for each destination. When there are accesses more than M times, update notice is not performed. In this case, a user performs update from a set-up screen.

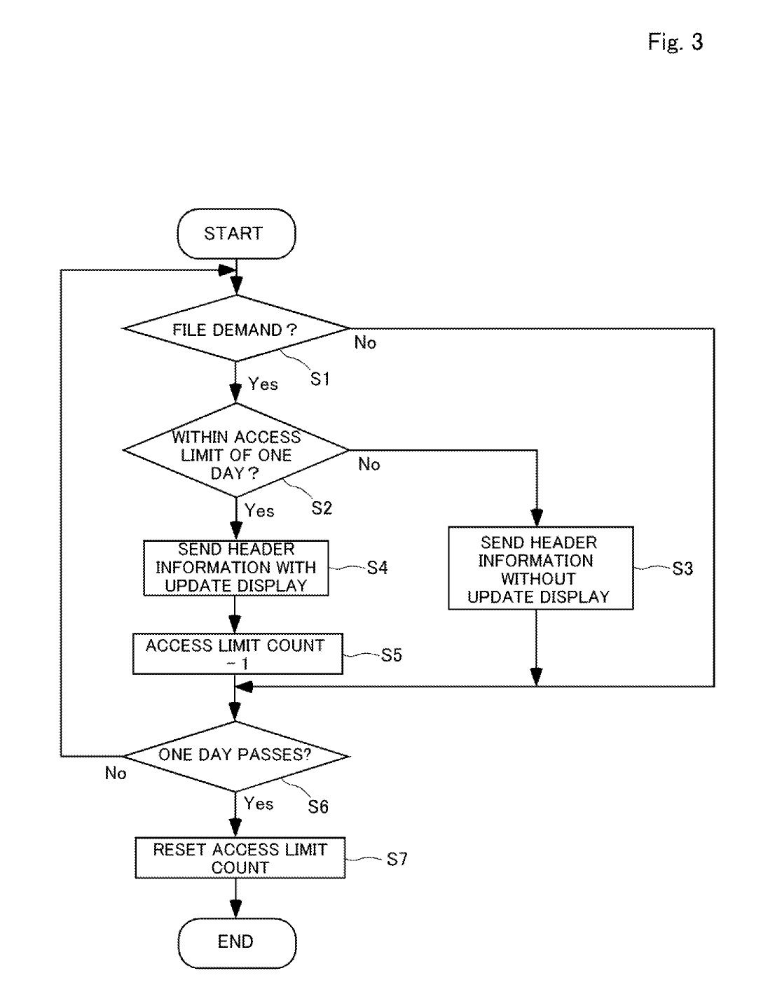

Processing operation of the server 5 is described based on a flow chart illustrated in FIG. 3. The microcomputer 501 judges whether there is a file demand from the AV receiver or not (S1). When the microcomputer 501 judges that there is a file demand from the AV receiver (S1: Yes), the microcomputer 501 judges whether access times are within access limit count of one day or not, namely, access limit count is 0 or not (S2). When the microcomputer 501 judges that access times is not within access limit count of one day, namely, access limit count is 0 (S2: No), the microcomputer 501 sends the header information without update display to the AV receiver (S3). Therefore, in the AV receiver, a message to ask the user to update firmware or not is not displayed.

When the microcomputer 501 judges that access times are within access limit count of one day, namely, access limit count is not 0(S2: Yes), the microcomputer 501 sends the header information with update display to the AV receiver (S4). Therefore, in the AV receiver, the message to ask the user to update firmware or not is displayed. When the user selects to update firmware, firmware update is performed by the AV receiver.

Next, the microcomputer 501 subtracts one from access limit count (S5). When the microcomputer 501 judges that there is not a file demand from the AV receiver (S1: No), the microcomputer 501 judges whether one day passes or not after processing of S3 or S5 (S6). When the microcomputer 501 judges that one day does not pass (S6: No), the microcomputer 501 performs processing of S1. When the microcomputer 501 judges that one day passes (S6: Yes), the microcomputer 501 resets access limit count (S7).

In this manner, access limit count is reset when date changes. And, access limit count is updated with a file demand first arrival order again. When there are accesses from the same AV receiver multiple times a day (or IP (Internet Protocol) address), multiple accesses are summarized to one count and count is not subtracted.

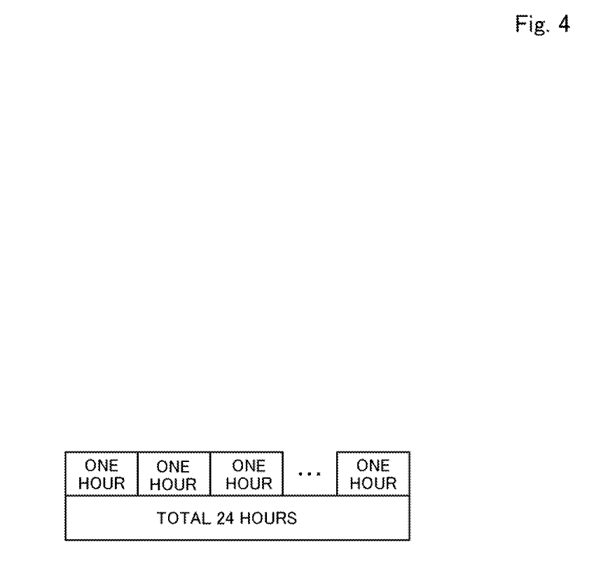

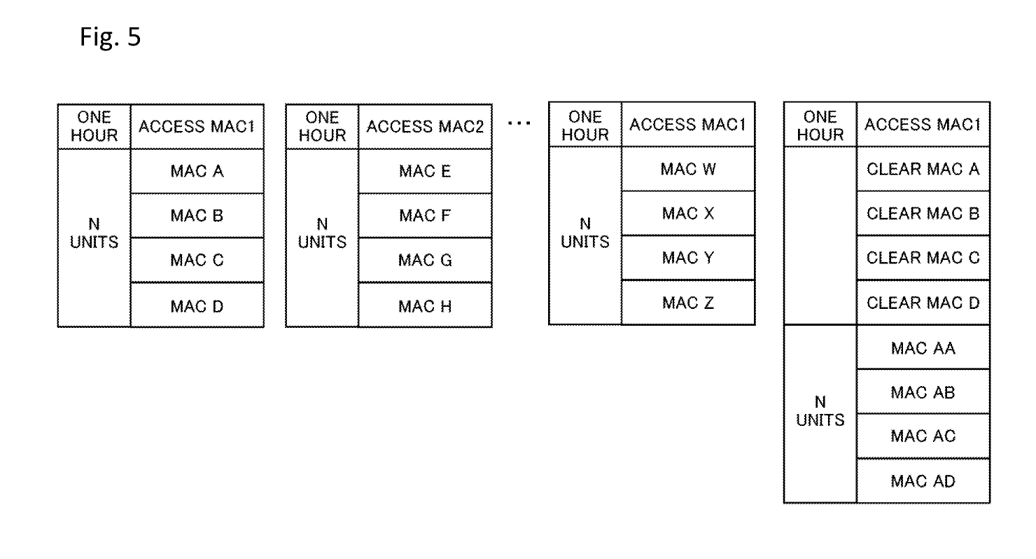

As described above, units of AV receivers to which update notices are sent per one day are limited. Units limit may be set per one hour, and limit is cleared per 24 hours (see FIG. 4). For example, upper limit of units of the AV receivers to which update notices are sent are N units. The microcomputer 501 sends update notices to the AV receivers until the AV receivers reach N units per an hour. When one hour passes, the microcomputer 501 resets upper limit. The microcomputer 501 sends update notices to the AV receivers until the AV receivers reach N units per one hour. Herein, as illustrated in FIG. 5, the microcomputer 501 records MAC addresses of the AV receivers which access per one hour to a table.

For example, in first one hour (access MAC 1), when there are accesses of AV receivers of MAC addresses MAC A, MAC B, MAC C and MAC D, the microcomputer 501 stores these MAC addresses. Further, the microcomputer 501 sends update notices to these AV receivers. In other words, the microcomputer 501 stores MAC addresses of the AV receivers to which update notices are sent.

Further, in next one hour (access MAC 2), when there are accesses of AV receivers of MAC addresses MAC E, MAC F, MAC G and MAC H, the microcomputer 501 stores these MAC addresses. Further, the microcomputer 501 sends update notices to these AV receivers. In other words, the microcomputer 501 stores MAC addresses of the AV receivers to which update notices are sent.

When there is access from the AV receiver of MAC address which is stored (recorded in the table), the microcomputer 501 does not send update notice to the AV receiver. The microcomputer stores MAC address for 24 hours. After 24 hours passes, the microcomputer 501 clears the MAC address. For example, the microcomputer 501 stores MAC addresses of MAC A, MAC B, MAC C, and MAC D. After 24 hours pass, the microcomputer 501 clears these MAC addresses.

And, newly, when there are accesses from AV receivers of MAC addresses MAC AA, MAC AB, MAC AC, and MAC AD, the microcomputer 501 stores these MAC addresses.

As described above, MAC addresses of MAC A to MAC D to which update notices are sent once are held in the table of access MAC 1 and update notices are not sent as long as 24 hours pass. For this reason, in the AV receiver, update display is not performed. After 24 hours pass, the table of access MAC 1 is discarded. Until AV receivers which newly access reach upper limit N units, update notices are sent and these MAC addresses are held in the table.

As described above, in the present embodiment, the microcomputer 501 sends update notices of firmware to AV receivers of a predetermined unit per predetermined time. Thus, concentration of accesses from AV receivers to the server 5 can be suppressed. In this manner, according to the present embodiment, firmware update by AV receivers can be controlled (suppressed) by simple means.

Further, in the present embodiment, the microcomputer 501 does not send update notice to AV receivers of which MAC addresses are stored. Thus, it is prevented that chances that the other AV receivers receive update notices are decreased by AV receivers to which update notice are sent once.

The embodiment of the present invention is described above, but the mode to which the present invention is applicable is not limited to the above embodiment and can be suitably varied without departing from the scope of the present invention.

In the above-mentioned embodiment, MAC address is illustrated as network address. Not limited to this, the network address may be IP address.

In the above-mentioned embodiment, the AV receivers 2 to 4 are illustrated as an electronic device. Not limited to this, the electronic device which includes firmware may be employed.

The present invention can be suitably employed in a firmware update system which updates firmware, and a server composing the firmware update system.

What is claimed is:

1. A server comprising a controller,
wherein the controller sends update notices of firmware to electronic devices of predetermined units per predetermined time.

2. The server according to claim 1,
wherein the controller sends a notice indicating that there is no firmware update to the other electronic devices when the controller sends update notices of firmware to electronic devices of predetermined units.

3. The server according to claim 1,
wherein the controller stores network addresses of electronic devices to which the update notices of firmware is sent.

4. The server according to claim 3,
wherein the controller does not send the update notices of firmware to electronic devices of which network addresses are stored.

5. The server according to claim 3,
wherein the controller deletes the stored network addresses after the controller stores network addresses and predetermined time passes.

6. A firmware update system comprising:
a server comprising a controller,
wherein the controller sends update notices of firmware to electronic devices of predetermined units per predetermined time,
and an electronic device.
